(19) United States
(12) Patent Application Publication
(10) Pub. No.: US 2012/0297283 A1
(43) Pub. Date: Nov. 22, 2012

(54) Priority filter viewer

(76) Inventors: Jason Moore, Taberg, NY (US); Patrick Fisher, Verona, NY (US)

(21) Appl. No.: 13/506,591

(22) Filed: Apr. 3, 2012

Related U.S. Application Data
(60) Provisional application No. 61/517,856, filed on Apr. 13, 2011.

(51) Int. Cl. G06F 17/00

(52) U.S. Cl. 715/227

(57) ABSTRACT

The Priority Filter View (PFV) provides a set of visual forms which allow for the user to interactively display, query, filter, sort, organize and disseminate information. This is done by exposing the relationships to the user without necessarily having to visually depict them. These relationships are often displayed with common graphical user interfaces which replicate the exact hierarchal data structures which exist in XML and folder style file systems. The PFV does not impose those rigid limitations, allowing the user to dictate the order in which content is filtered and displayed.

### PRIORITY CLAIM UNDER 35 U.S.C. §119(e)

This patent application claims the priority benefit of the filing date of a provisional application Ser. No. 61/517,856, filed in the United States Patent and Trademark Office on Apr. 13, 2011.

### STATEMENT OF GOVERNMENT INTEREST

The invention described herein may be manufactured and used by or for the Government for governmental purposes without the payment of any royalty thereon.

### BACKGROUND OF THE INVENTION

Filtering and organizing related information has become a problem with data analysis in the current age; this is exacerbated as the quantity, dimensionality and availability of data increases. With vast amounts of information and their interrelationships, it is difficult to find anything useful within even relatively small datasets. Users quickly become overwhelmed with sorting and finding data in cases where relevant information can be lost amidst unrelated content, misrepresented data, or when the cost of retrieval processing and interaction behavior is simply too prohibitive.

### OBJECTS AND SUMMARY OF THE INVENTION

The present invention, i.e., a Priority Filter Viewer (PFV), consists of a Graphical User Interface (GUI) component and a backend data store which gives the ability to view, prioritize, query, disseminate and filter linked data. The invention helps users answer desired questions by interacting dynamically with the component in order to filter or highlight these relationships. The canonical implementation does this through the use of a tabular data representation, but other visual metaphors and modalities have been explored. This invention, when manifested with both traditional and touch devices, offers an intuitive user interaction with data.

The invention's goal is to display and filter related information in a way that users can easily prioritize for presentation. In order to create the canonical implementation of this invention, it requires objects that digest, view, and relate the data to each other. Objects also need to be created which keep track of the state of the information. In the present invention implementation they are these objects are referred to as StateManagers. StateManagers store what data is visibly displayed, selected and highlighted at a given time. DataTables provide access to the data for the View. The View uses DataTables and StateManagers to visualize the effects of any user interaction.

Digesting the information is done by users either having the information in an already digestible state or implementing DataTables to digest the information. DataTables are interfaces that can retrieve data from a backend data store such as, a graph, database, file system, web stream, or any other data source the user defines.

The canonical implementation of the invention defines that each DataTable is associated with a View, which contains a JComponent, in order to show the information. The canonical implementation also allows users to associate the DataTable with other predefined views like a JTable or 3D View. A View defines what object(s) from the DataTable(s) are viewed at any particular time.

The last object required by the present invention is a RelationModel, which informs the invention how to relate content between DataTables. The canonical object is a simple interface that requires the user to implement a method that specifies how the data entries within two DataTables are related.

With all these components defined, the invention shows the graphical representation of the filterable contents of all the desired views and allows the invention to manage and prioritize the relationship(s).

The invention allows users to define the filtering process in any order to give a desired result. The filtering process could be a selection of data, simple question, query, or much more. In the table view implementation, altering the priority of the filter is accomplished simply by dragging tables to change the column order. Selection within the table also changes the filtering process by: eliminating filtering, adding filtering, or changing the currently filtered view. Filtering is extensible within the invention and is not limited to table-based data selection. Some examples of these filtering mechanisms include, but are not limited to, a conditional statement, user selection of information from another view, or by specifying a geographical bounding box on a map.

### BRIEF DESCRIPTION OF THE DRAWINGS

FIG. 1 depicts the filtering process of the PFV and the effect of re-ordering columns.

FIG. 2 depicts the relationship between data sources, data tables, state managers, views, and relationship models.

FIG. 3 depicts the flow process for determining the display of a row of data in a data table column.

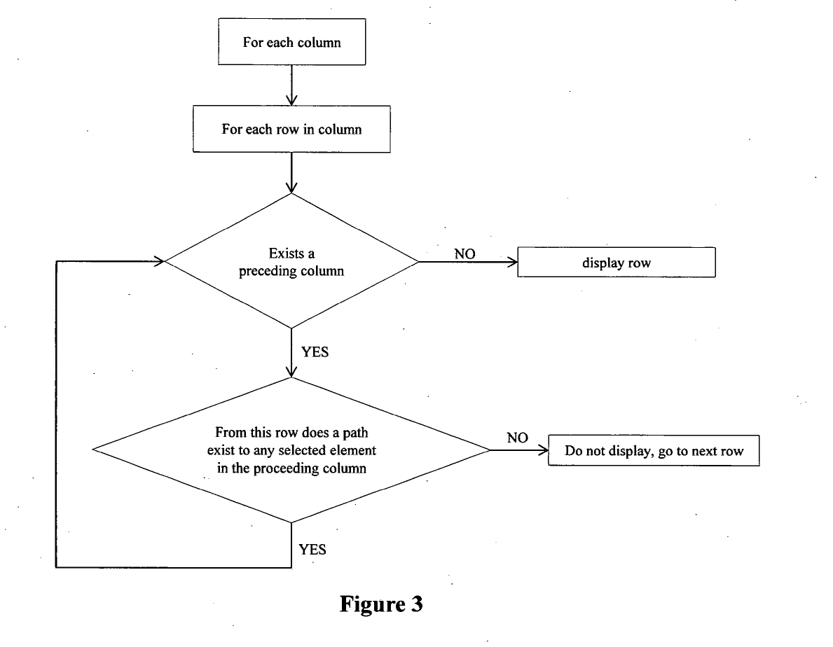

FIG. 4 depicts a simple PFV dataset for use with FIGS. 5, 6, 7, and 8.

FIG. 5 depicts the initial state with no selected values.

FIG. 6 depicts the effect of re-ordering columns.

FIG. 7 depicts the effect of a selection performed in the Orange column after the reordering in FIG. 6.

FIG. 8 depicts the effect of ignoring the existence of a particular column.

FIG. 9 depicts an example graph that will be used in FIGS. 4-6, the numeric values in this instance represent latitude and longitude in decimal degrees.

FIG. 10 depicts an example where other external filters can be used in conjunction with the invention.

### DETAILED DESCRIPTION OF THE PREFERRED EMBODIMENT

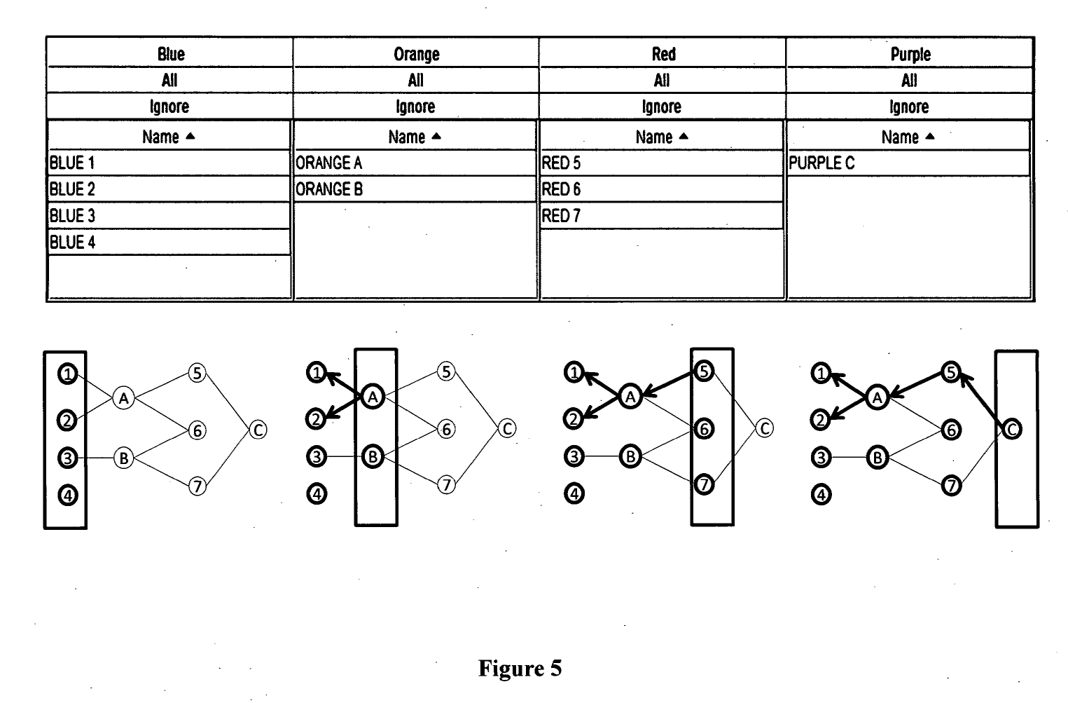

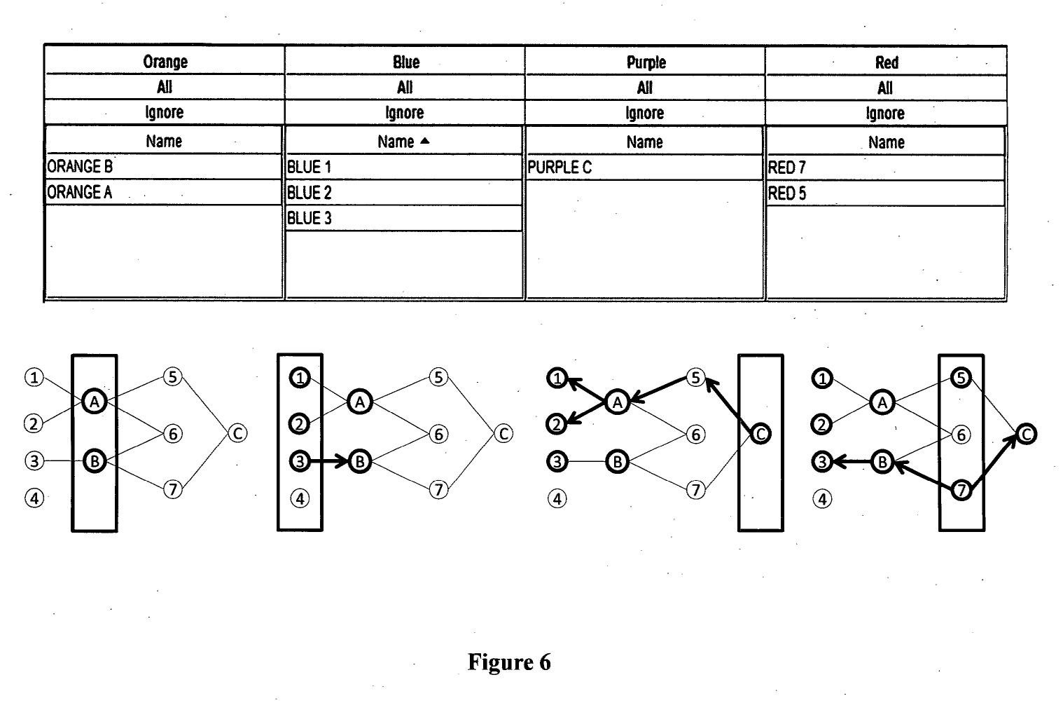

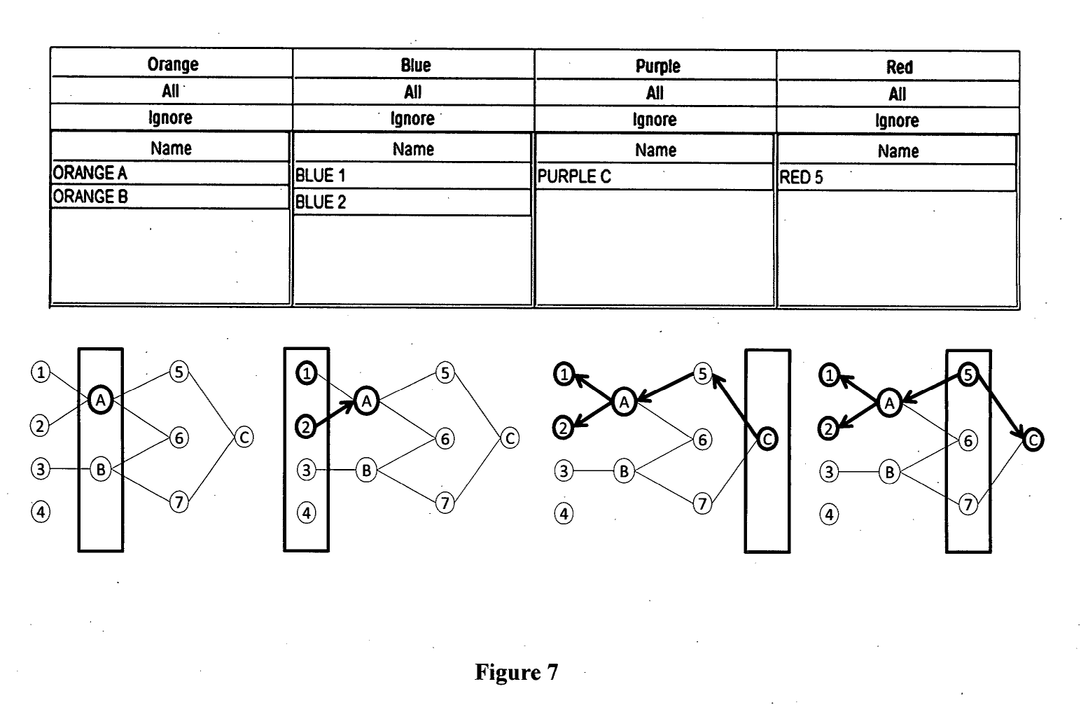

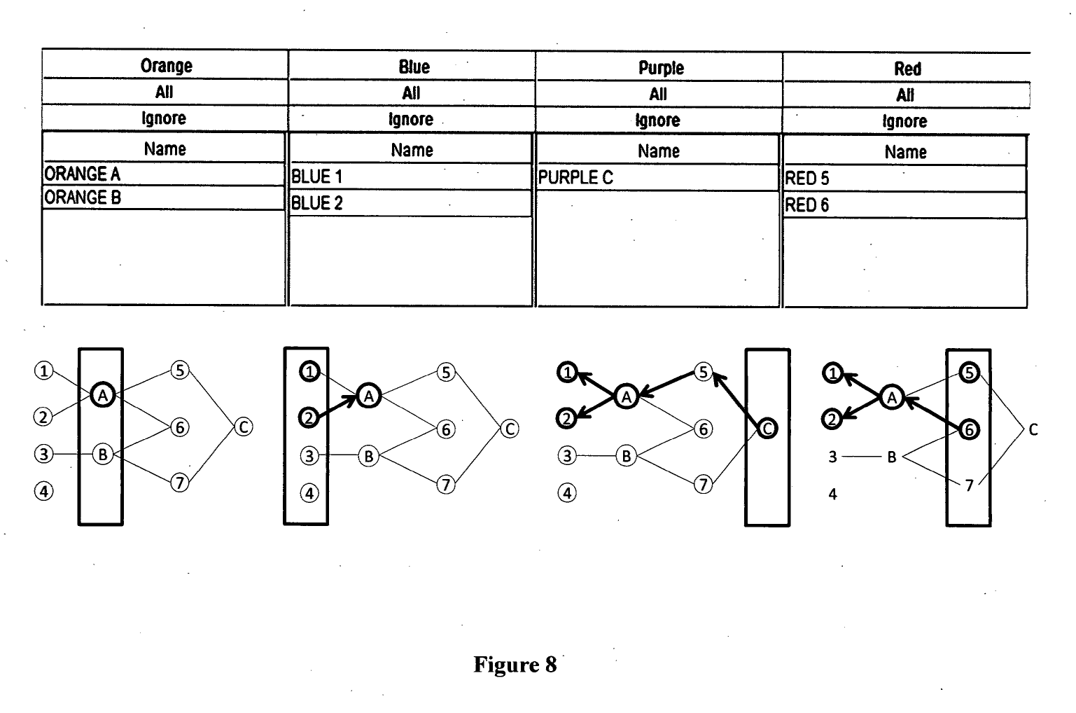

The present invention, called a Priority Filter Viewer, takes as input the groups of data and their interrelationships. The invention's table implementation creates tables for each grouping to be prioritized and filtered based on user driven selections. Tables can be promoted (moved to the left) or demoted (moved to the right) to determine the order of filtering. The first (leftmost) column is the primary index, showing all the elements. The second column shows all the elements that have relationships with the selected elements of the first column. To simplify the interface and remove clutter, the preferred embodiment treats no-selection as though all elements in the column were selected. In FIG. 5, FIG. 6, FIG. 7, and FIG. 8, there exists an “All” selection that depicts this property. Subsequent columns will only display data related to all previously selected cells of columns with higher precedence. If data isn't displayed in a column, it cannot be assumed that the adjacent column of higher precedence filtered the information, only that one or more of the higher precedence columns resulted in a filter that eliminated the data. The workflow does not restrict the developer to this type of filtering behavior and in fact, any behavior based on the relationships between the groupings may be defined. In the preferred embodiment, a relationship denotes direct connections between data elements and is not propagated through secondary connections. Direct connections between data elements are not necessary and can be extended trivially to other connectivity decisions in the RelationshipModel but are done for simplicity.

Additionally, other visual forms may be used for result visualization after the filtering process is performed or to provide impetus to the filtering process. These visual forms may consist of, but are not limited to: graphs, maps, flow charts, or SQL statements.

One embodiment of the present invention utilizes locally or remote data stores and relationships to depict the users' filtering priorities through columns where the leftmost column has the highest priority and subsequent columns follow suit. Other embodiments use the PFV in a strict filtering mode where all the columns are interrelated. These relationships potentially results in a narrowing of the content visible downstream based on the users' selections and hidden relationships underlying the data. The preferred embodiment utilizes StateManagers, DataTables and a RelationModel to extract and calculate the visibility of any particular element based on any upstream filter. The user can quickly change priorities by swapping column locations which may results in more or less data being visible.

Sources such as databases, XML files, CSV files, SOAs, graphs, and hardcoded data have all been utilized as DataTables for the PFV.

Other visual metaphors have been explored and/or implemented which include hexagonal representations, geospatial views, tag clouds, graphs, charts, and multi-element tables. Other concepts such as nested PFVs, inverse selection mechanisms, brushing techniques which expose the RelationModel, cascading PFVs which display the negative of the selection, and more have been explored.

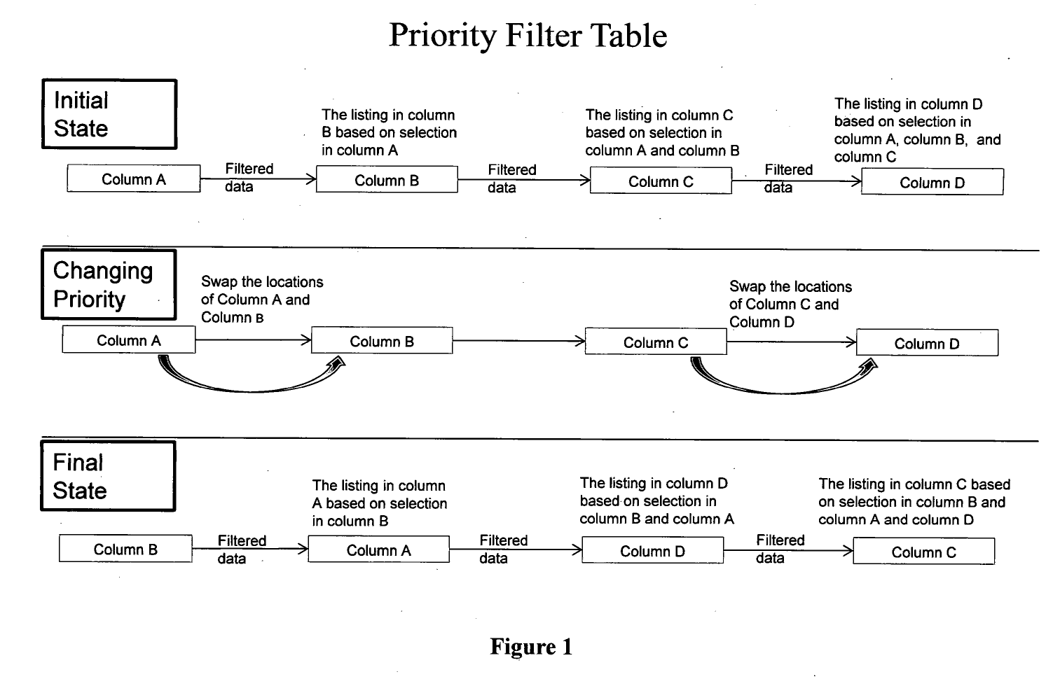

Referring to FIG. 1 depicts the filtering process starting with the default column locations and the filtering precedence proceeds from the leftmost column to the rightmost column. At each transition, the subset of the data is provided downstream. After changing the priority, which in the preferred embodiment is performed by moving the column order, the final state depicts the updated filtering process. Column ordering is not the only mechanism to define filter precedence, other mechanisms are trivially covered.

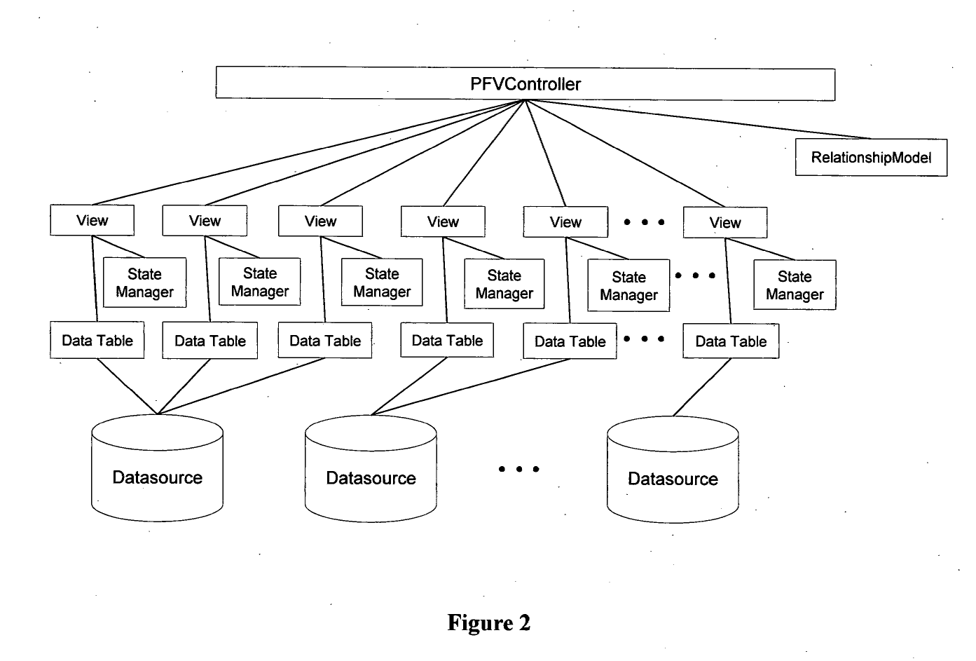

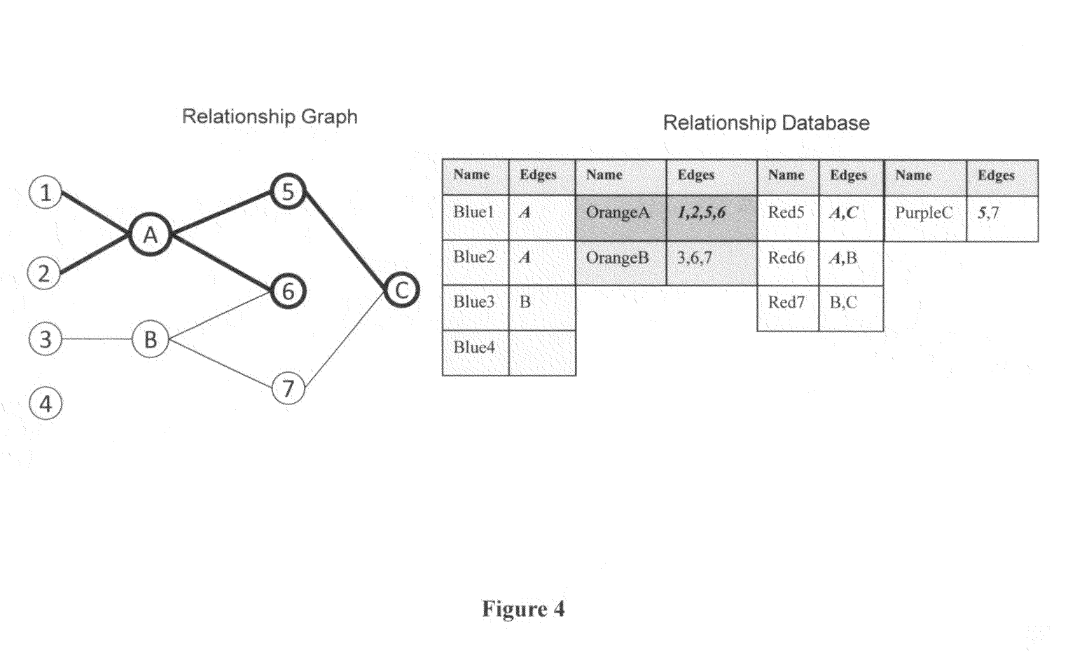

Referring to FIG. 2 depicts an example of both a relationship graph and a relationship database representation of the content used in FIGS. 4, 5, 6, 7, and 8. In the graph representation, lines between elements represent relationships. In the database representation, relationships are stored as edges in the Edges columns. In support of FIGS. 7 and 8, the graph edges are depicted with a bold black border indicating the ORANGE A element is selected and bold black lines are used to show the associated relationships. In the database representation, the same content is depicted by shading the selected cell gray and edges are highlighted in bold and italic.

Referring to FIG. 4 depicts the preferred embodiment in the initial state.

Referring to FIG. 5 we define the priority to be the columns (Blue, Orange, Red, and Purple) using the defined graph in FIG. 4. Elements in the table that are selected are highlighted. The reachability graph is highlighted for ORANGE A. When this column renders, each element (in this case ORANGE A) checks to see if it is reachable from the selected elements in all previous columns such that directionality is maintained, i.e. no loops can be created. The reachability graph is highlighted for RED 5. When this column renders, each element (in this case RED 5) checks to see if it is reachable from the selected elements in all previous columns such that directionality is maintained, i.e. no loops can be created. Notice that the connection to RED 6 via ORANGE A is not highlighted, since no loops can be made, the order of the traversal to previous or subsequent columns is maintained in the preferred embodiment, i.e. the traversal direction is not changed. The reachability graph is highlighted for PURPLE C. When this column renders, each element (in this case PURPLE C) checks to see if it is reachable from the selected elements in all previous columns such that directionality is maintained, i.e. no loops can be created. Notice that the connection to RED 6 via ORANGE A is not highlighted, since no loops can be made, the order of the traversal to previous or subsequent columns is maintained in the preferred embodiment, i.e. the traversal direction is not changed.

Referring to FIG. 6 depicts the effect of swapping the Orange and Blue columns, and swapping the Purple and Red columns. Swapping the Orange and Blue columns eliminates BLUE 4 from the view since there does not exist a relationship between any of the elements in the primary Orange column and BLUE 4. Swapping the Red and Purple columns eliminates RED 6 from the view since there does not exist a relationship between any of the elements in the tertiary PURPLE column and RED 6.

Still referring to FIG. 6, the location of the columns has been altered so as to define the priority to be (Orange, Blue, Purple, and Red) using the defined graph in FIG. 2. Elements in the table that are selected are highlighted. In this case, all the elements are selected. The reachability graph is highlighted for BLUE 3. When this column renders, each element (in this case BLUE 3) checks to see if it is reachable from the selected elements in all previous columns such that directionality is maintained, i.e. no loops can be created. Notice that BLUE 4 is not visible since there does not exist a connection from previously selected items. The reachability graph is highlighted for PURPLE C. When this column renders, each element (in this case PURPLE C) checks to see if it is reachable from the selected elements in all previous columns such that directionality is maintained, i.e. no loops can be created. Even though the Red column is subsequent in the tabular view, a path still exists that connects PURPLE C to selected elements in the Blue and Orange columns. In this case {BLUE 1 or BLUE 2 or BLUE 3}, and {ORANGE A or ORANGE B}. The reachability graph is highlighted for RED 7. When this column renders, each element (in this case RED 7) checks to see if it is reachable from the selected elements in all previous columns such that directionality is maintained, i.e. no loops can be created. Notice that RED 6 is not visible since there does not exist a one-way path that emanates from RED 6 connecting it to PURPLE C.

Referring to FIG. 7 depicts selection of ORANGE A, which removes BLUE 3, and subsequently, causes the removal of RED 7. Here, the user defines the priority to be the columns (Orange, Blue, Purple, and Red) using the defined graph in FIG. 2. Red 7 is ultimately filtered out by selecting ORANGE A. Elements in the table that are selected are highlighted. In this case, only ORANGE A is selected. The reachability graph is highlighted for BLUE 2. When this column renders, each element (in this case BLUE 2) checks to see if it is reachable from the selected elements in all previous columns such that directionality is maintained, i.e. no loops can be created. Notice that BLUE 3 and BLUE 4 are not visible since there does not exist a connection from previously selected items, in this case only ORANGE A. The reachability graph is highlighted for PURPLE C. When this column renders, each element (in this case PURPLE C) checks to see if it is reachable from the selected elements in all previous columns such that directionality is maintained, i.e. no loops can be created. Even though the Red column is subsequent in the tabular view, a path still exists that connects PURPLE C to selected elements in the Blue and Orange columns. In this case {BLUE 1 or BLUE 2}, and {ORANGE A}. The reachability graph is highlighted for RED 5. When this column renders, each element (in this case RED 5) checks to see if it is reachable from the selected elements in all previous columns such that directionality is maintained, i.e. no loops can be created. Notice that RED 6 and RED 7 are not visible since there does not exist a one-way path that emanates from either element to selected elements in the Orange, Blue and Purple columns. In this case {ORANGE A} and {PURPLE C} and, {BLUE 1 or BLUE 2}.

Referring to FIG. 8 depicts ignoring the Purple column, which adds RED 6 back to the Red column since there is a direct connection between ORANGE A and RED 6 which was originally filtered by PURPLE C in FIG. 7. Here, the user defines the priority to be the columns (Orange, Blue, Purple, and Red) using the defined graph in FIG. 4. By changing the purple column from the “All” state to the “Ignore” state, Red 6 appears because Purple C is not filtering Red 6. Elements in the table that are selected are highlighted. In this case, only ORANGE A is selected. The reachability graph is highlighted for BLUE 2. When this column renders, each element (in this case BLUE 2) checks to see if it is reachable from the selected elements in all previous columns such that directionality is maintained, i.e. no loops can be created. Notice that BLUE 3 and BLUE 4 are not visible since there does not exist a connection from previously selected items, in this case only ORANGE A. The reachability graph is highlighted for PURPLE C. When this column renders, each element (in this case PURPLE C) checks to see if it is reachable from the selected elements in all previous columns such that directionality is maintained, i.e. no loops can be created. Even though the Red column is subsequent in the tabular view, a path still exists that connects PURPLE C to selected elements in the Blue and Orange columns. In this case {BLUE 1 or BLUE 2}, and {ORANGE A}. The reachability graph is highlighted for RED 6. When this column renders, each element (in this case RED 6) checks to see if it is reachable from the selected elements in all previous columns such that directionality is maintained, i.e. no loops can be created. Since the Purple column is ignored, then only reachability to selected elements in the Orange and Blue columns are required. In this case {ORANGE A} and {BLUE 1 or BLUE 2} is required for visibility. Notice that RED 7 is still not visible since there does not exist a one-way path that connects to {ORANGE A} and, {BLUE 1 or BLUE 2}.

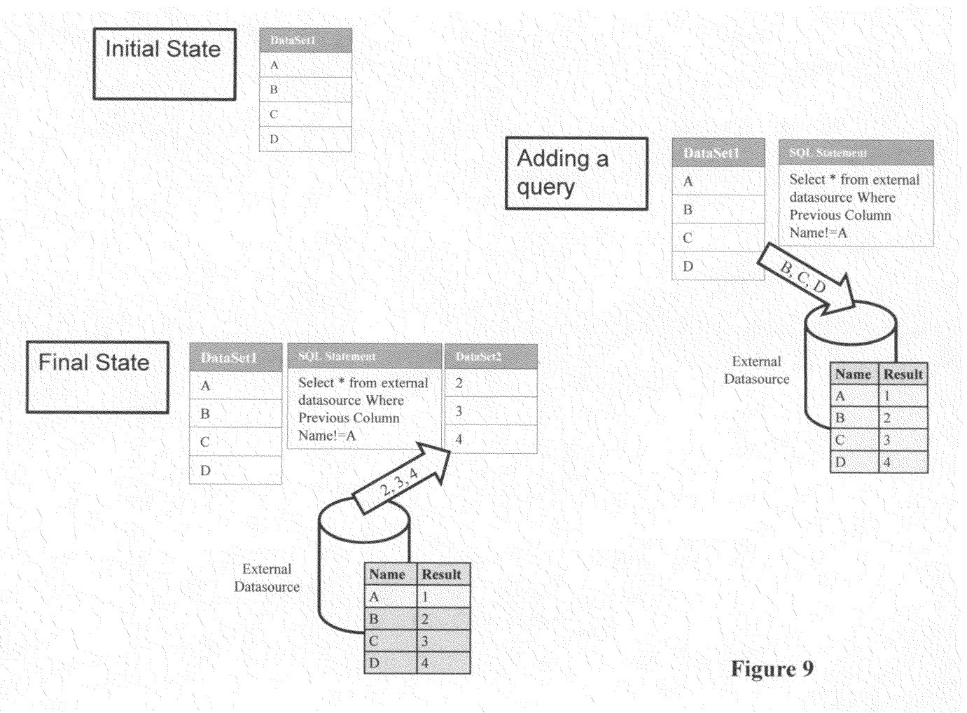

Referring to FIG. 9 depicts using an SQL statement to insert data. While the previously described implementation for the preferred embodiment has “all” the data loaded and columns visible, this is not required and implementations exist where data is injected into the filtering stream. This exposes new columns to the interface and results in an expansion instead of contraction of downstream data.

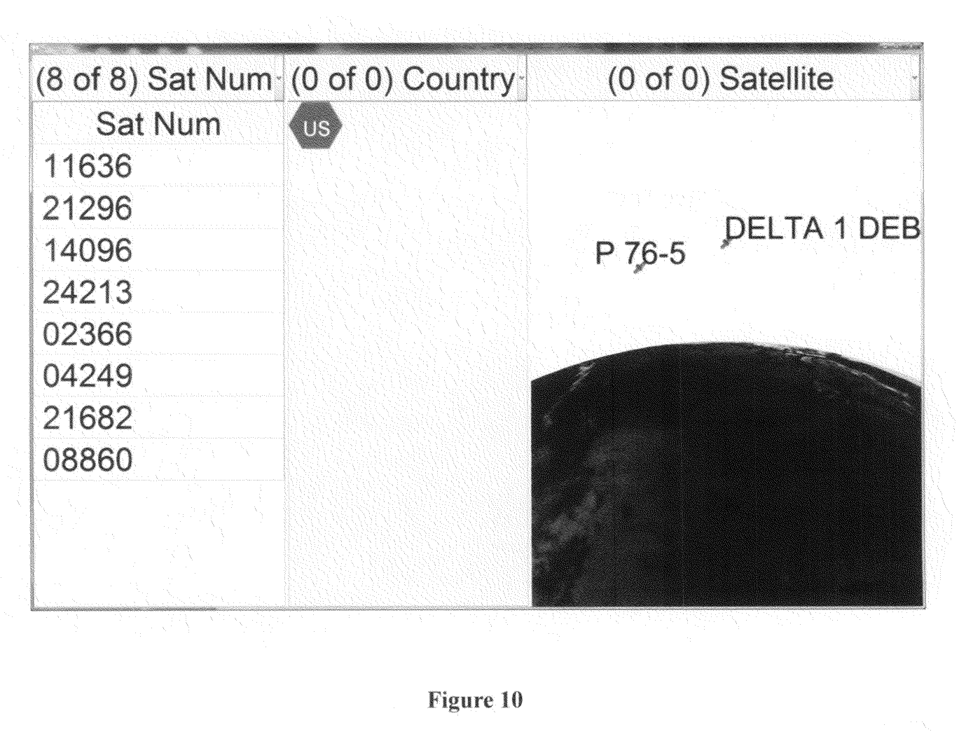

Referring to FIG. 10 (not intended to be legible) depicts the use of multiple visual and filtering/selection mechanisms used to explore a Keyhole Markup Language (KML) file containing satellite information. This KML file is organized in an Extensible Markup Language (XML) format and has a predefined hierarchy where the top most categorization is the satellite type (Active, Inactive, Rocket Body, or Debris), followed by Country (US, UK, IT . . . ), then finally by satellite name. Each satellite record contains additional data about the satellite, such as satellite number, launch date, etc. Traditional visualizations depicting this rigid tree structure limit the user's ability to explore this data unfettered. Using the PFV frees the user from the limited pre-built filtering structure imposed by XML data sources.

Still referring to the implementation depicted in FIG. 10 displays and filters the content from left to right starting with the satellite number in a traditional tabular format, the country in a tightly packed hexagonal representation, another traditional table with the type of satellite, a tag cloud where the size and color of the text is based on the eccentricity of the satellite, a tabular listing of the launch date, with the last column providing a visual representation of the location of the satellites geospatially over a 3 dimensional globe. This example shows but a subset of the visual metaphors possible and the utility of this filtering in conjunction with datasources that have an embedded hierarchical structure.

The invention supports a myriad of capabilities, which include, but are not limited to, adding columns, removing columns, ignoring columns, displaying in non-column formats, having resulting visualizations that do not impact downstream filtering, expanding data based upon values on upstream selections, and many more. The examples described thus far are but a subset of the capabilities possible with the PFV and it is trivial to combine these capabilities. Other, non-selection based, filters have also been utilized such as regular expressions and Boolean check operators for values in the table.

The invention is very applicable to solving common problems where large, interrelated datasets need to be explored and understood, such as viewing, sorting, and filtering music repositories, movie lists, photographic archives, and stored television shows.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method for providing a filtered presentation of information by prioritizing said information's inter relationships, comprising the steps of:
retrieving said information from a data store using a plurality of data tables;
tracking the state of said information using a state manager;
wherein said state manager stores data that is visible, selected, and highlighted;
relating content between said data tables using a relation model;
associating each of said data tables with a view;
wherein said view defines which objects from each of said data tables are displayed at any given time; and
wherein said view utilizes said data tables and said state manager to visualize the effects of a user's interaction; and
displaying said views.

2. The method claim 1, wherein said data tables form columns and rows.

3. The method of claim 2 wherein said data table columns are promoted to the left or demoted to the right of a view to determine the order of data filtering; wherein
leftmost data tables columns contain an index of all data elements; and
data table columns to the right contain elements that have relationships with selected elements of a data table column to the nearest left.

4. The method of claim 3, wherein a user may exchange the locations of said data table columns so as to:
reorder relationships between data tables; and
change priority of said filtered presentation of said data tables.

5. The method of claim 4:
when, for each said row in each said column of a data table column there does not exist a preceding data table column to the left, said row is displayed;
otherwise,
when for said row there is no relational path to any selected element in a preceding data table column to the left,
said row is not displayed;
increment down to next row in said data table column;
otherwise,
return to said step of determining when, for each said row in each said column of a data table column there does not exist a preceding data table column to the left.
